(19) United States
(12) Patent Application Publication
(10) Pub. No.: US 2004/0015992 A1
(43) Pub. Date: Jan. 22, 2004

(54) Device for controlling capture device and storage device via LAN, and capture device, storage device, program and method therefor

(75) Inventors: Eiji Hasegawa, Kawasaki (JP); Toshihiro Sonoda, Kawasaki (JP); Fumio Honda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/340,754

(22) Filed: Jan. 13, 2003

(30) Foreign Application Priority Data
Jul. 18, 2002 (JP) 2002-210129

(51) Int. Cl. H04N 7/173

(52) U.S. Cl. 725/86; 725/89

(57) ABSTRACT

A system includes a plurality of data stream capture devices, one or more storage devices and a plurality of user devices, all of which are connectable to each other via a LAN. The user device transmits a request to the capture device in accordance with a user's request, and transmits a request to said storage device in accordance with a user's request. When it is determined that the capture device is tunable to a channel for a desired broadcast program, in accordance with a received request, the capture device is tuned to the channel, and receives and provides a data stream of the program. In accordance with a received request, the storage device records the data stream of the desired program from the capture device which is tuned to the channel. In accordance with a received request, the storage device transmits a desired recorded data stream.

### FIELD OF THE INVENTION

The present invention relates to receiving, recording and delivering a broadcast program to user devices via a local area network (LAN), and more particularly to a shared system for receiving, recording, and delivering a broadcast program to user devices via a LAN.

### BACKGROUND OF THE INVENTION

In a common condominium, a receiving antenna is shared by a plurality of households via a distribution cable, and each user couples tuners of a recording and reproducing device and a television apparatus to the distribution cable. The user can record only one broadcast program by using one recording and reproducing device.

In Japanese Unexamined Patent Publication No. 11-112562 (A), Fukazawa et al. discloses a technique in which a conversion server converts the protocol of video data received from a video server into an HTTP protocol for a client, and the converted video data is transmitted to the client.

In Japanese Unexamined Patent Publication No. 2001-344271 (A), Takemura discloses a technique in which a stream data reproducing device collects stream data from other computers in accordance with selected states of each user and stores the collected data into storage means for the user, and the stream data stored in the storage means for the user is delivered to a computer of the user in response to a request of the user.

In Japanese Unexamined Patent Publication No. 2002-101370 (A), Iwamoto discloses a technique in which a server is connected to terminals of users via the Internet, different broadcast program data received from a tuner unit is collectively recorded in response to requests for recording from the terminals of the users, and the program data is delivered to the terminal of the user in response to a request for viewing from the terminal. However, one tuner can not simultaneously receive different programs on different channels.

The inventors have recognized that it is advantageous that a plurality of devices or terminals of a plurality of users share a plurality of broadcast program capture devices and a broadcast program storage device, by interconnecting, via a LAN, the plurality of broadcast program capture devices, the broadcast program storage device and the plurality of devices or terminals.

It is an object of the invention to enable a broadcast program capture device and a broadcast program storage device to be shared by devices of a plurality of users.

In accordance with an aspect of the present invention, a control device is connectable to a plurality of data stream capture devices and one or more storage devices via a local area network. The control device comprises a processor. The processor is adapted to request, in response to a user's request, one of the plurality of capture devices to be tuned to a desired channel and receive a desired data stream, when it is determined that the one capture device is tunable to the channel. The processor is adapted to request, in response to the user's request, one of the one or more storage devices to record the data stream from the one capture device, when it is determined that the one storage device can record the data stream.

The processor is adapted to request one of the plurality of capture devices to be tuned to a channel on which a data stream desired by a user can be received and to receive and provide the desired data stream, when the desired data stream is currently being broadcast, and when it is determined that the one capture device is tunable to the channel. The processor is adapted to request one of the one or more storage devices that stores the data stream desired by the user to provide the desired data stream, when it is determined that the desired data stream was broadcast in the past.

In accordance with another aspect of the invention, a data stream capture device is connectable to one or more storage devices and to a plurality of user devices via a local area network. The data stream capture device comprises a processor and a tuner. The processor is adapted to cause, in accordance with a received request, the tuner to be tuned to a desired channel and to receive a desired data stream, when it is determined that the tuner is tunable to the channel. The processor is adapted to transmit in response to a received request, the data stream in a predetermined format to the user device. The processor is adapted to transmit the data stream to the storage device in response to a received request.

In accordance with a further aspect of the invention, a storage device is connectable to a plurality of data stream capture devices and a plurality of user devices via a local area network. The storage device comprises a processor and a recording medium. The processor is adapted to record, in response to a received request, a desired data stream from the capture device on a recording medium, when it is determined that a data stream can be recorded on the recording medium. The processor is adapted to provide in response to a received request, a data stream recorded on the recording medium, in a predetermined format, to one of the plurality of user devices.

In accordance with a still further aspect of the invention, a program (which may be stored on a storage medium) is for use in a data stream capture device which is connectable to one or more storage devices and to a plurality of user devices via a local area network. The program being operable to effect the steps of: causing, in accordance with a received request, a tuner to be tuned to a desired channel and to receive a desired data stream, when it is determined that the tuner is tunable to the channel; transmitting, in response to a received request, the data stream in a predetermined format to the user device; and transmitting the data stream to the storage device in response to a received request.

In accordance with a still further aspect of the invention, in an information processing device which is connectable to a plurality of data stream capture devices and to one or more storage devices via a local area network, a method is for controlling the plurality of data stream capture devices and the one or more storage devices. The method comprises the steps of: requesting, in response to a user's request, one of the plurality of capture devices to be tuned to a desired channel and receive a desired data stream, when it is determined that the one capture device is tunable to the channel; and requesting, in response to the user's request, one of the one or more storage devices to record the data stream from the one capture device, when it is determined that the one storage device can record the data stream.

According to the invention, a broadcast program capture device and a broadcast program storage device can be shared by devices of a plurality of users. The required number of broadcast program capture devices and the required number of broadcast program storage devices can be connected to a LAN. The plurality of broadcast program capture devices and the plurality of broadcast program storage devices can be distributed on the LAN at different locations.

Throughout the drawings, similar symbols and numerals indicate similar items and functions.

### BRIEF DESCRIPTION OF THE DRAWINGS

FIG. 1 shows the configuration of a local area network (LAN) in accordance with an embodiment of the present invention;

FIG. 2 shows the configuration of a LAN in accordance with another embodiment of the invention;

FIG. 3 shows the configuration of a LAN in accordance with a further embodiment of the invention;

FIG. 4 shows the configuration of a LAN in accordance with a still further embodiment of the invention;

FIG. 5 shows the configuration of a capture device shown in FIGS. 1 to 4.

FIG. 6 shows the configuration of the storage device shown in FIGS. 1 to 4;

FIG. 7 shows the configuration of a control device shown in FIGS. 1 and 2;

FIG. 8 shows the configuration of a reproduction and display device shown in FIGS. 2 and 4;

FIGS. 9A and 9B show relations between a command from the control device and replies from the capture devices and the storage devices;

FIG. 10A shows an example of a command for searching for a capture device by the control device;

FIG. 10B shows an example of a reply described in the XML from the capture device;

FIG. 11A shows delivery of an electronic program guide (EPG) by the capture device;

FIG. 11B shows an example of a conversion table;

FIG. 11C shows an example of EPG data delivered to the control device;

FIG. 12A shows an example of an EPG displayed on a display device or a terminal;

FIG. 12B shows an example of a list of recorded programs which is produced by the storage device;

FIGS. 13A and 13B show control signals for controlling the capture device and the storage device by the control of the control device in accordance with a request by a user;

FIG. 14 is a flowchart for controlling a capture device that is executed by the control device, as shown in FIG. 13A;

FIG. 15 is a flowchart for controlling the storage device that is executed by the control device, as shown in FIG. 13A;

FIG. 16 is a flowchart for reserving the capture device for use that is executed by the control device, as shown in FIG. 13A;

FIG. 17 is a flowchart for reserving the storage device for use that is executed by the control device, as shown in FIG. 13A;

FIG. 18 is a flowchart for presenting a program that is executed by the control device, as shown in FIG. 13B;

FIG. 19 is a flowchart for reserving the capture device for use and rearranging the reservations depending on the receiving channels of the capture devices that is executed by the control device, as shown in FIG. 13B;

FIG. 20 shows an example of a procedure for changing storage devices for recording a data stream of a program, performed between one storage device and another storage device;

FIG. 21 is a flowchart for switching the storage devices for recording a data stream of a broadcast program that is executed by the storage device;

FIG. 22 shows the configuration of a content server shown in FIGS. 3 and 4;

FIG. 23 is a flowchart for receiving requests for reservations of recording broadcast programs from the plurality of user terminals that is executed by a server function of the content server; and

FIG. 24 shows an example of a list of reservations stored in a reservation file.

### DESCRIPTION OF PREFERRED EMBODIMENTS

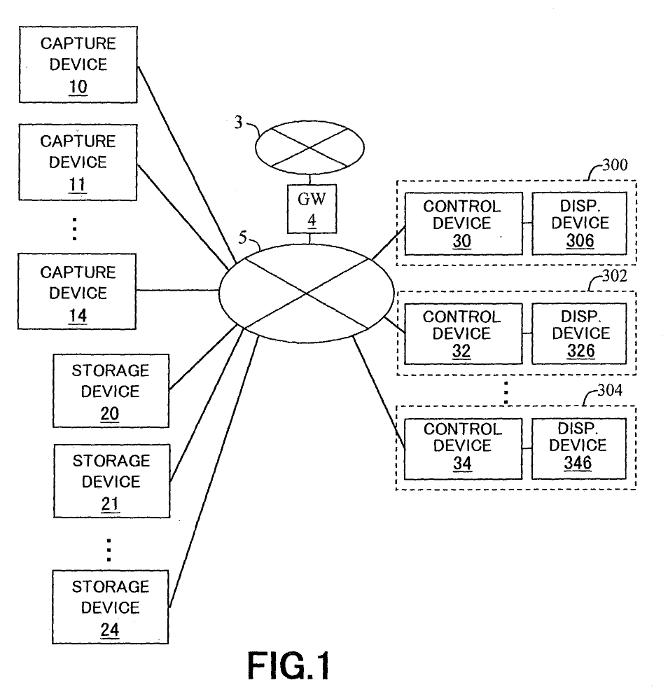

FIG. 1 shows a plurality of capture devices 10, 11, . . . and 14 for capturing data streams of broadcast programs from external sources of signals, such as an antenna for the terrestrial broadcast, an antenna dish for the satellite broadcast and a cable for the cable television (CATV) system, a plurality of storage devices 20, 21, . . . and 24 for storing or recording signals captured by the capture devices 10 to 14, and users' control devices 30, 32, . . . and 34 coupled to respective display devices 306, 326, . . . and 346, all of which are connected to a local area network (LAN) 5 provided in an area, such as a condominium, in accordance with an embodiment of the present invention. The LAN 5 may be a network of any kind on which connection can be provided in accordance with the Internet protocol (IP), for example, Ethernet®, a wireless LAN, or a power-line carrier bus. The LAN 5 is connected to an external network 3, such as the Internet, via a gateway 4. A set 300 of the control device 30 and the display device 306, a set 302 of the control device 32 and the display device 326, . . . and a set 304 of the control device 34 and the display device 346 are installed in respective households of the users. Each of the control devices 30 to 34 may be a dedicated unit, a set-top box or a personal computer (PC). The display devices 306 to 346 may be television apparatuses. Alternatively, each of the sets 300 to 304 may be included in one personal computer (PC).

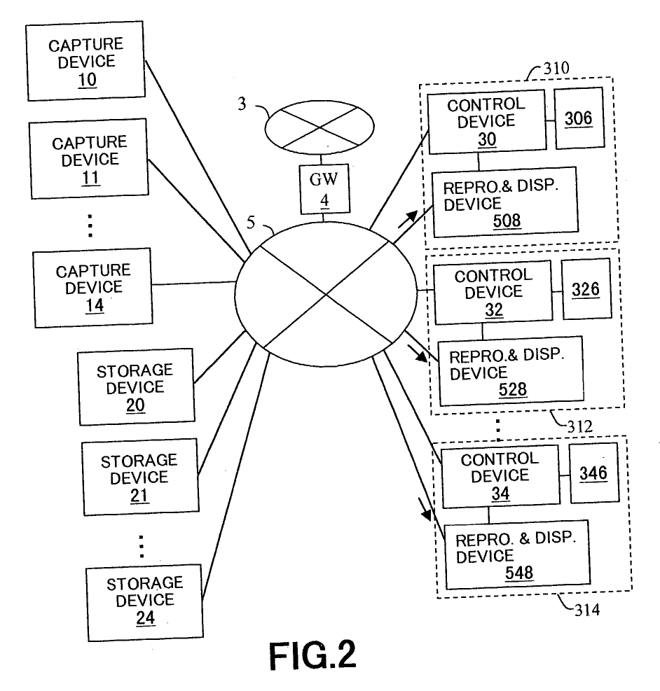

FIG. 2 shows a plurality of capture devices 10, 11, and 14, a plurality of storage devices 20, 35 21, . . . and 24, users' control devices 30, . . . and 34 coupled to respective display devices 306, 326 . . . and 346, and reproduction and display devices 508, 528, . . . and 548 for reproducing a data stream for display, all of which are connected to a LAN 5, in accordance with another embodiment of the invention. The LAN 5 is connected to an external network 3 via a gateway 4. A set 310 of the control device 30, the display device 306 and the reproduction and display device 508, a set 312 of the control device 32, the display device 326 and the reproduction and display device 528, . . . and a set 314 of the control device 34, the display device 346 and the reproduction and display device 548 are installed in the respective households of the users. In place of the display devices 306 to 346, the reproduction and display devices 508 to 548 may be used. Each of the control devices 30 to 34 may be a dedicated unit, or a PC. Each of the reproduction and display devices 508 to 548 may be a combination of a set-top box connected to the LAN 5, and a television apparatus.

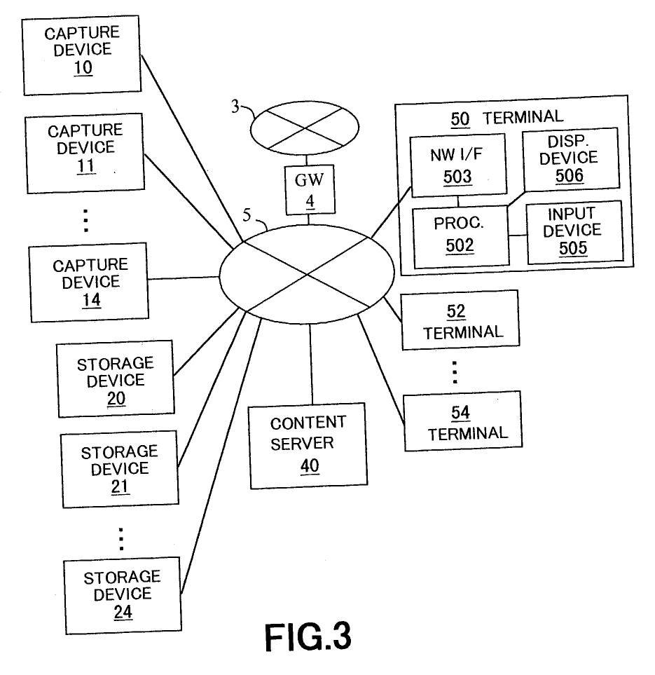

FIG. 3 shows a plurality of capture devices 10, 11, . . . and 14, a plurality of storage devices 20, 21, . . . and 24, a content server or a central control device 40 which manages the capture devices 10 to 14 and the storage devices 20 to 24, and users' terminals 50, 52, . . . and 54, all of which are connected to a LAN 5. in accordance with a further embodiment of the invention, The LAN 5 is connected to an external network 3 via a gateway 4. Each of the users' terminals 50, 52, . . . and 54 includes: a processor 502 for controlling internal components and modules and generating a network command; a network interface (NW I/F) 503; an input device 505, such as a keyboard and a mouse; and a display device 506. The terminals 50 to 54 are installed in the respective households of the users. The terminals 50 to 54 may be PCs or television apparatuses.

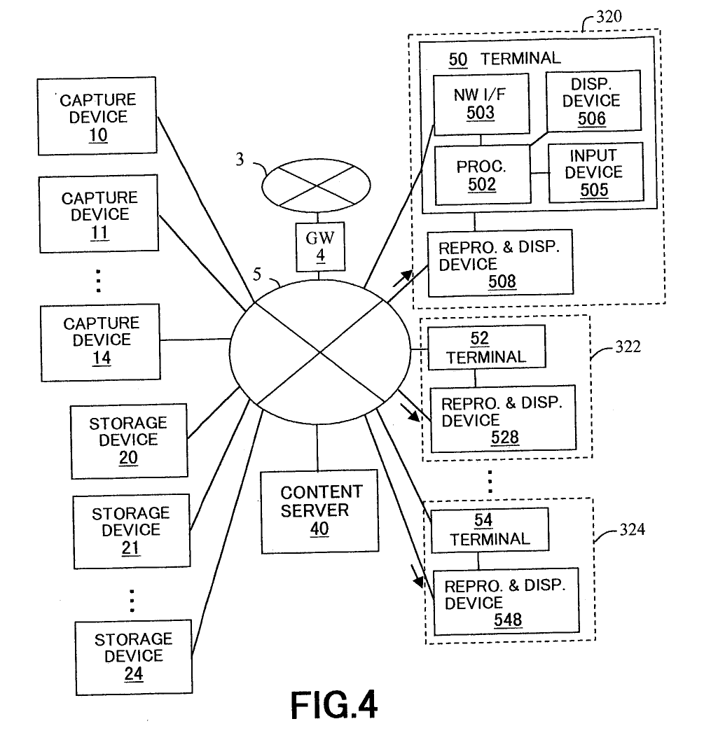

FIG. 4 shows a plurality of capture devices 10, 11, . . . and 14, a plurality of storage devices 20, 21, . . . and 24, a content server or a central control device 40 which manages the capture devices 10 to 14 and the storage devices 20 to 24, users' terminals 50, 52, . . . and 54, and reproduction and display devices 508 , 528, . . . and 548, all of which are connected to a LAN 5, in accordance with a still further embodiment of the invention. The LAN 5 is connected to an external network 3 via a gateway 4. Each of the users' terminals 50, 52, . . . and 54 includes: a processor 502 for controlling internal components and modules and generating a network command; a network interface (NW I/F) 503; an input device 505, such as a keyboard and a mouse; and a display device 506. A set 320 of the terminal 50 and the reproduction and display device 508, a set 322 of the terminal device 52 and the reproduction and display device 528, . . . and a set 324 of the terminal 54 and the reproduction and display device 548 are installed in the respective households of the users. The terminals 50 to 54 may be a PC or a PDA (Personal Digital Assistant). Each of the reproduction and display devices 508 to 548 may be a combination of a set-top box connected to the LAN 5 and a television apparatus.

According to the embodiments, different broadcast programs from the two or more capture devices can be simultaneously recorded in the one storage device, or one broadcast program can be divided and recorded in the two or more storage devices.

FIG. 5 shows the configuration of each of the capture devices 10 to 14 in FIGS. 1 to 4. Each of the capture devices 10 to 14 includes: a controller and analyzer module 110 for controlling internal components and modules; a tuner 120 which is coupled to external signal sources such as an antenna for receiving a terrestrial broadcast signal, an antenna dish for receiving a satellite broadcast signal, and/or a cable for receiving a CATV signal; a protocol converter 130 which converts protocols of data streams; a network interface (NW I/F) 140 which is connected to the LAN 5; a power supply control device 150; a memory 160; and an authentication module 170. The controller/analyzer 110, the converter 130 and the authentication module 170 are implemented on the processor in the form of hardware or software.

In response to a command (CMD) which is received via the LAN 5, the controller/analyzer 110 controls the tuner 120, the converter 130, and the network interface 140 to derive a desired data stream in a broadcast format from a received RF signal and causes the derived data stream to be converted in terms of protocol into a data stream in a transmission format, so as to provide, via the LAN 5, the converted data stream to the storage devices 20 to 24, the control devices 30 to 34, and the terminals 50 to 54 or the reproduction/display devices 508 to 548. The tuner 120 down-converts a desired RF signal on a desired channel into an IF signal, then down-converts the IF signal into a base band signal, then demodulates the base band signal, then decrypts or descrambles the demodulated signal, if necessary, and decodes the resultant signal to reproduce the broadcast data stream. In order to deliver an encrypted broadcast program to the control devices 30 to 34, the controller/analyzer 110 may transmit an encrypted key for decryption or descrambling to authorized ones of the control devices 30 to 34, the terminals 50 to 54, or the reproduction and display devices 508 to 548.

The capture devices 10 to 14 receive a data stream in the broadcast format of MPEG2-TS, and transmit a data stream in the LAN transmission format of MPEG2-TS/RTP. The converter 130 converts a data stream in the broadcast format into a data stream in the LAN transmission format. The controller and analyzer 110 can cause the converter 130 to convert the bit rate of the received data stream into one of a plurality of bit rates having different picture qualities and/or sound qualities in accordance with a request by a receiving device, which may be the control device, the terminal or the reproduction and display device for example, to deliver the data stream at the converted bit rate.

The memory 160 stores information related to the identification and address of a corresponding capture device, the identification, the date and the period of time of a broadcast program, current and reserved tuned channels, the ID of a user who has made the reservation, the identification and address of the control device or the terminal, the identification and the address of the reproduction and display device, and the like.

When the capture devices 10 to 14 do not perform the reception, conversion and delivery of a data stream, the power supply control device 150 deenergizes components and modules other than the network interface 140, the control/analyzer 110 and the like which are necessary for receiving a command via the LAN 5, for the purpose of energy saving. Each memory 160 of the capture devices 10 to 14 holds information related to the capture devices 10 to 14, for example, information on the receivable broadcast channels, and reservations for tuning and receiving.

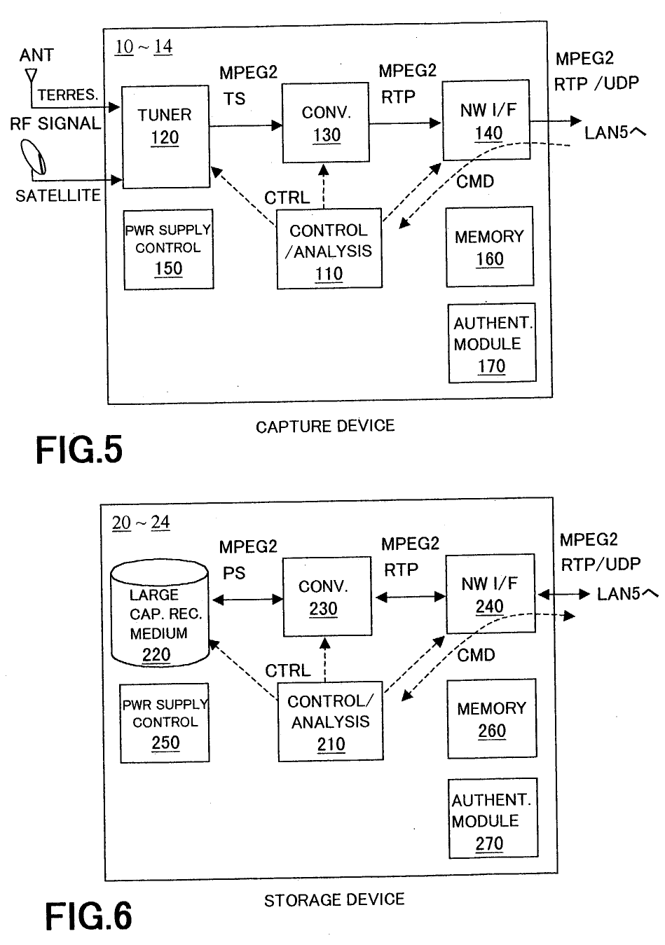

FIG. 6 shows the configuration of each of the storage devices 20 to 24 in FIGS. 1 to 4. Each of the storage devices 20 to 24 includes: a controller and analyzer module 210 for controlling internal components and modules; a storage medium 220 having a large capacity such as a hard disk for storing data streams of broadcast programs; a protocol converter 230 which converts protocols of data streams; a network interface (NW I/F) 240 which is connected to the LAN 5; a power supply control device 250; a memory 260; and an authentication module 270. The controller/analyzer 210, the converter 230 and the authentication module 270 are implemented on the processor in the form of hardware or software.

The memory 260 stores a list of reservations of recording broadcast programs and recorded broadcast programs. In particular, the memory 260 stores information related to the identification and the address of the corresponding storage device, the identification, the date and the period of time of the broadcast program to be recorded, the indication of whether the program has been recorded or not, the identification and address and the tuned channel of the capture device to be utilized, the ID of the user who has made the reservation, the identification and address of the terminal, the identification and address of the reproduction and display device, a threshold value of the number of data streams which can be simultaneously recorded, and the like. When a plurality of users request recording of the same program, the IDs of all the users who have made the reservations, the identifications and addresses of the terminals, and the identifications and addresses of the reproduction and display devices are stored into the memory 260.

In response to a command (CMD) received via the LAN 5, the controller/analyzer 210 controls the large-capacity storage medium 220, the converter 230 and the network interface 240 to perform protocol conversion on a data stream of a broadcast program in the transmission format received via the LAN 5 into a data stream in the storage format and store the data stream, and perform protocol conversion on the stored data stream of the broadcast program in the storage format into a data stream in the transmission format to thereby provide, via the LAN 5, the data stream to the control devices 30 to 34, the reproduction and display devices 508 to 548 or the terminals 50 to 54.

When the amount of stored data on the storage medium 220 reaches or is going to reach the limit, the controller/analyzer 210 deletes older ones of the stored broadcast programs. Alternatively, when the amount of stored data on the storage medium 220 reaches or is going to reach the limit, the controller/analyzer 210 deletes ones of the stored broadcast programs that have lower priorities. The priorities are assigned to the stored broadcast programs by the user, as described later.

When deletion of a stored program in the storage devices 20 to 24 is requested by the user through the control devices 30 to 34, the controller/analyzer 210 deletes the corresponding user ID and like data in the list stored in the memory 260. When all of the user IDs and like data related to a particular program in the list are deleted, the controller/analyzer 210 deletes the particular program.

The storage devices 20 to 24 transmit and receive data streams in the LAN transmission format of MPEG2-TS/RTP, and store the data stream in the storage format of MPEG2-PS. The converter 230 performs conversion of the data stream format between the LAN transmission format and the storage format. The controller/analyzer 210 can cause the converter 230 to convert the bit rate of the stored data stream into one of a plurality of bit rate formats in accordance with a request of a receiving device, which may be the control device, the terminal, or the reproduction and display device for example, to deliver the converted data stream.

When none of the reception, conversion and delivery of a data stream occurs, the power supply control device 250 deenergizes the components and modules other than the network interface 240, the controller/analyzer 210 and the like which are necessary for receiving a command via the LAN 5, for the purpose of energy saving.

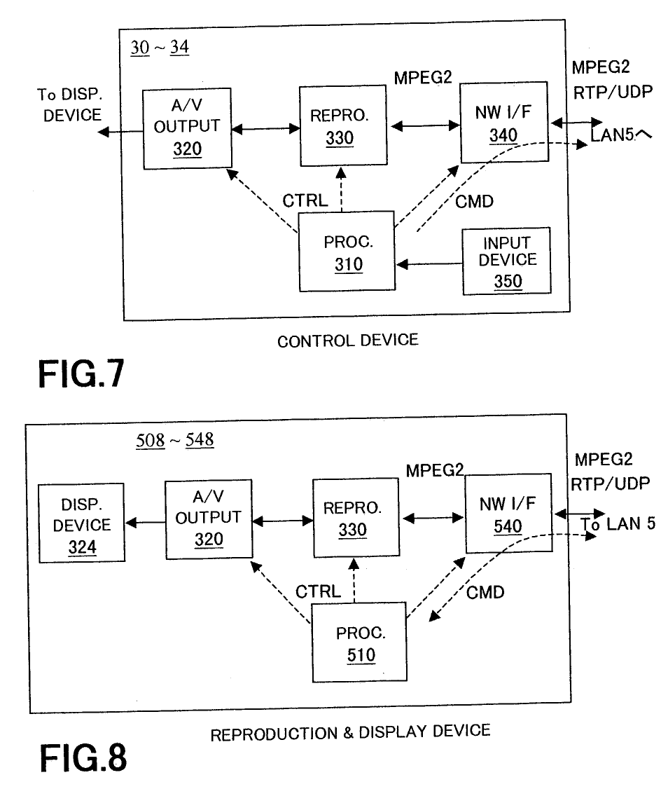

FIG. 7 shows the configuration of each of the control devices 30 to 34 in FIG. 1. Each of the control devices 30 to 34 includes: a processor 310 for controlling internal components and modules; a network interface (NW I/F) 340 which is connected to the LAN 5; a reproducer 330 which reproduces audio and video data streams of a broadcast program from a data stream in the transmission format; an audio/video output unit 320 which is coupled to the corresponding display device (306 to 346); and an input device 350, such as a keyboard. The reproducer 330 is implemented on the processor in the form of hardware or software.

The control devices 30 to 34 shown in FIG. 2 have the same configuration as that shown in FIG. 7. However, it is assumed that the control devices 30 to 34 in FIG. 2 do not receive a data stream of a broadcast program, and the reproducer 330 does not reproduce the data stream of the broadcast program. However, the data stream of the broadcast program is received and reproduced by the reproduction and display devices 508 to 548.

In accordance with an operation of the input device 350 by a user, the processor 310 controls the audio/video output unit 320, the reproducer 330, and the network interface 340 to transmit, via the LAN 5, a command to the capture devices 10 to 14 and the storage devices 20 to 24, and to receive and reproduce a data stream of a broadcast program from the capture devices 10 to 14 and the storage devices 20 to 24 to provide the reproduced data stream to the display devices 306 to 346.

Each of the terminals 50 to 54 in FIG. 3 includes arrangement similar to that of the control devices 30 to 34 shown in FIG. 7, and includes the reproducer 330 and the audio/video output unit 320. Each of the terminals 50 to 54 in FIG. 3 can transmit a command for controlling the content server 40, to the content server 40 via the LAN 5.

Each of the terminals 50 to 54 in FIG. 4 can transmit a command for controlling the content server 40 and a command for controlling the associated reproduction and display devices 508 to 548, to the content server 40 and the associated reproduction and display device 508 to 548 via the LAN 5, respectively.

FIG. 8 shows the configuration of each of the reproduction and display devices 508 to 548 in FIGS. 2 and 4. Each of the display devices 508 to 548 includes: a processor 510 for controlling internal components and modules; a network interface (NW I/F) 540 which is connected to the LAN 5; a reproducer 330 which reproduces a data stream of a broadcast program; an audio/video output unit 320; and a display device 324. The reproducing device 330 is implemented on the processor in the form of hardware or software.

In accordance with a command, the processor 510 controls the audio/video output unit 320, the display device 324, the reproducer 330 and the network interface 540 to transmit a command to the capture devices 10 to 14 and the storage devices 20 to 24 via the LAN 5, to receive and reproduce a data stream of a broadcast program from the capture devices 10 to 14 and the storage devices 20 to 24, to provide the reproduced data stream to the display device 324. The processor 510 receives a command together with a URL from the control devices 30 to 34 in FIG. 2 or from the content server 40 in FIG. 4, and accesses one of the capture devices 10 to 14 and the storage devices 20 to 24 that is associated with the URL, to receive a data stream of a broadcast program.

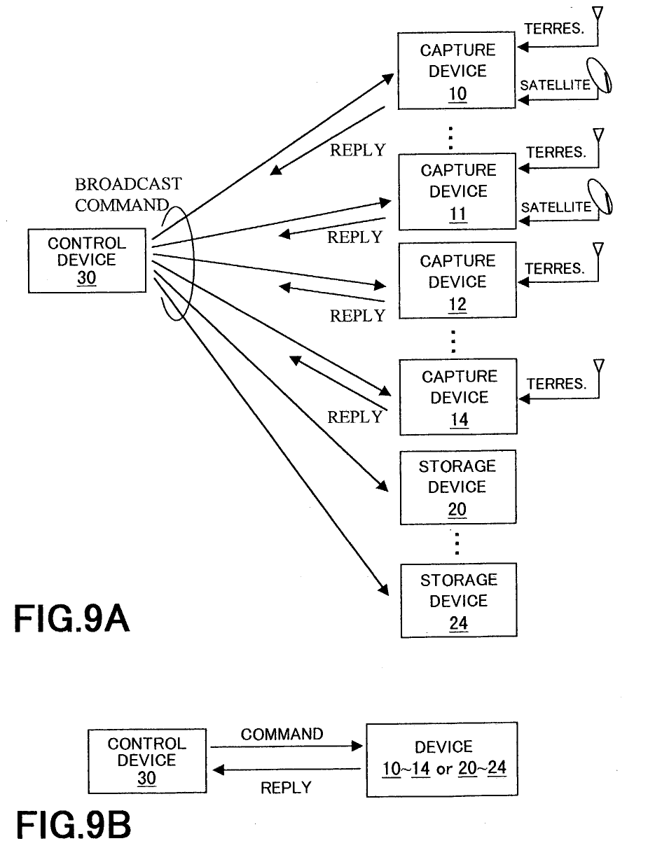

FIG. 9A shows relations between a search command from the control device 30, and replies from the capture devices 10 to 14 and the storage devices 20 to 24. The other control devices 32 to 34 operate in the same way as the control device 30. The control device 30 broadcasts a command together with the identification and address of the control device, the user ID and the password, to the capture devices 10 to 14 and the storage devices 20 to 24. One of the capture devices 10 to 14 and the storage devices 20 to 24 that is designated by the command authenticates the user by using the authentication module 170 or 270, and replies to the command.

FIG. 9B shows conventional relations between a network command from the control device 30, and replies from the capture devices 10 to 14 and the storage devices 20 to 24. The control device 30 transmits a command together with the identification and address of the control device, the user ID and the password, to a particular one of the capture devices 10 to 14 and the storage devices 20 to 24 at its the address. The device (10 to 14, or 20 to 24) replies to the command in a similar manner.

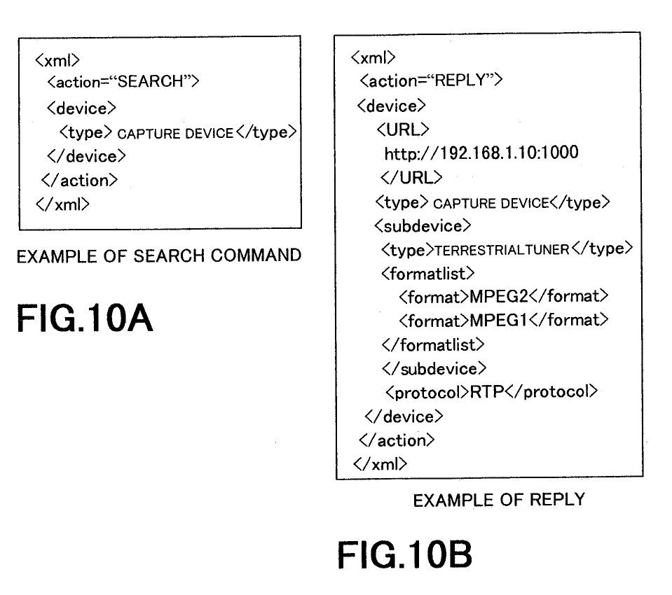

FIG. 10A shows an example of a command described in XML (eXtensible Markup Language) of the control device 30 for searching a capture device. When a user requests recording or receiving a particular broadcast program through the input device 350, the control device 30 first transmits a search command packet in the form of UPnP (Universal Plug and Play) shown in FIG. 10A, in order to collect information related to various functions of the capture devices 10 to 14.

FIG. 10B shows an example of a reply described in XML from the capture devices 10 to 14. Each of the capture devices 10 to 14 transmits a reply, as shown in FIG. 10B, back to the control device 30. The reply includes the identification and address or URL (for example, http://192.168.1.10:1000) of the capture device 10 to 14, the type of the tuner 120, the standard format (for example, MPEG1 and MPEG2) of the data stream, the protocol (for example, RTP), and the like. The control device 30 also collects information related to different functions of the storage devices 20 to 24. Thus, the control device 30 detects the presence and the number of network devices, and holds the list of the devices in a RAM.

When each of the capture devices 10 to 14 and the storage devices 20 to 24 is first connected to the LAN 5, the device broadcasts an announce packet including device information shown in FIG. 10B as an example, so as to inform the control devices 30 to 34.

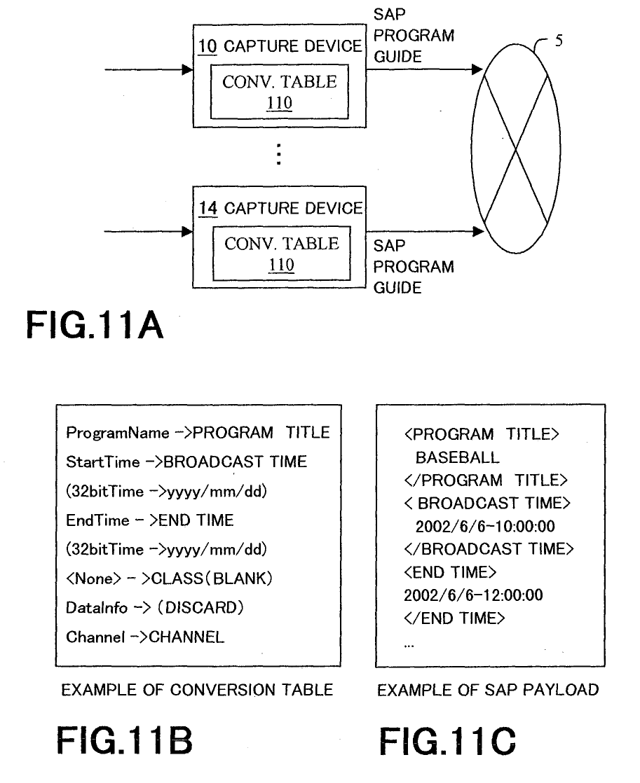

FIG. 11A shows delivery of an electronic program guide (EPG) by the capture devices 10 to 14. Some of the capture devices 10 to 14 regularly receive an EPG on a particular channel for an EPG for the terrestrial broadcast, the satellite broadcast, the CATV system, and the like at, for example, 1:00 a.m. every day or 1:00 a.m. on every Saturday, or access a Web page for an EPG via the LAN 5 and the external network 3, so as to capture an EPG for a predetermined period, such as one day or one week.

The converters 130 of the capture devices 10 to 14 convert the protocol of the EPG captured by using a conversion table 110 described in the form of, for example, XSLT into a protocol such as SAP (Session Announcement Protocol), and then transmit the program guide to the control devices 30 to 34 or the terminals 50 to 54. FIG. 11B shows an example of the conversion table 110. For example, item “ProgramName” is converted into a field “PROGRAM TITLE”, and “StartTime” is converted into “BROADCAST TIME”. The 32-bit time is converted into characters in the form of “yyyy/mm/dd”. After the conversion, an item in which corresponding data is not included in the EPG is set to be blank. If converted item data corresponding to that included in the EPG is not included in the conversion table, the item data is discarded.

FIG. 11C shows an example of EPG data described in SAP and delivered to the control devices 30 to 34. In response to a request by the control devices 30 to 34, or to reception of a new EPG, the capture devices 10 to 14 deliver the EPG data, as shown in FIG. 11C, to the control devices 30 to 34.

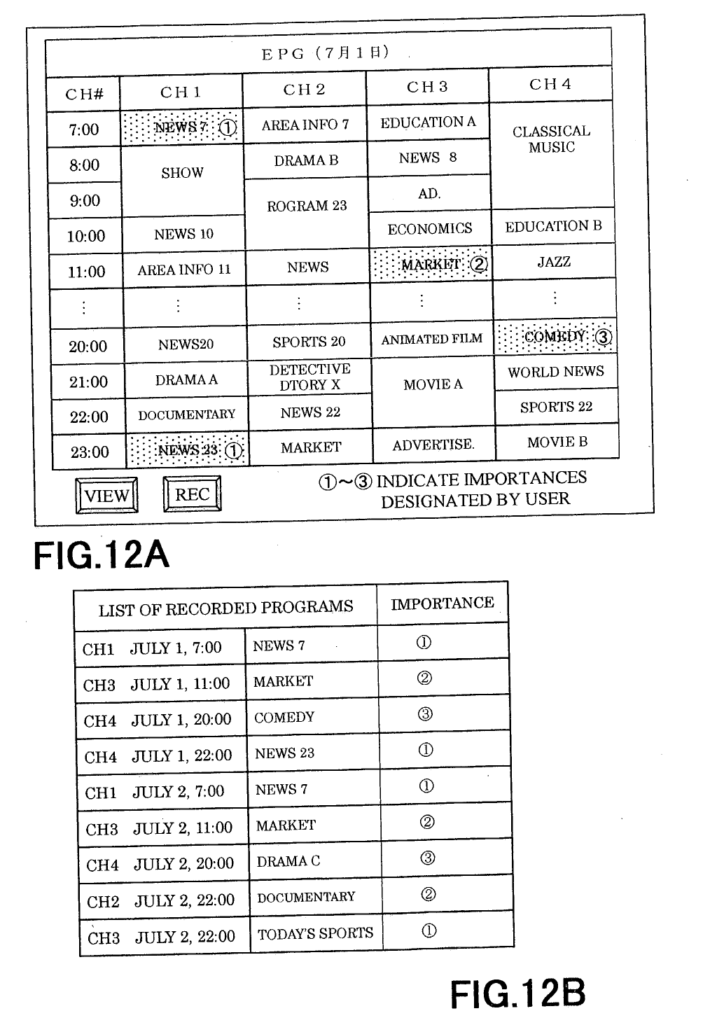

FIG. 12A shows an example of an EPG displayed on the display devices 306 to 346 or the terminals 50 to 54 (the display device 506). A user points a program in the EPG and then presses a software button of “VIEW” or “RECORD”, so as to view or record the program. When the user selects recording of a program, he or she may assign an importance or priority, for example, either one of 1 to 3 to the program. When the importance is not assigned by the user, the importance is set to a default value of, for example, 2. A program with higher importance is preferentially recorded and stored by the storage devices 20 to 24. FIG. 12B shows an example of a list of stored programs which is produced by the storage devices 20 to 24.

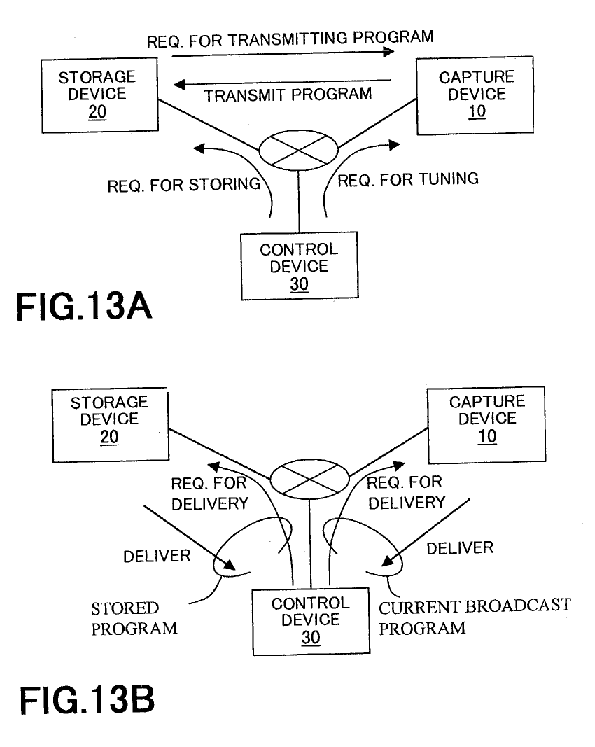

FIGS. 13A and 13B show control signals for controlling the capture device 10 and the storage device 20 by the control device 30 in accordance with a request by a user.

Referring to FIG. 13A, in order to record a broadcast program desired by the user, the control device 30 transmits, to an appropriate capture device or the device 10, a command for transferring a data stream of a broadcast program which is received by tuning to a particular channel for a desired period of time. The control device 30 then transmits a command for storing the data stream of the broadcast program from the capture device 10 for the period of time, to an appropriate storage device or the device 20. The storage device 20 requests the capture device 10 to transfer the data stream of the broadcast program received for the period of time, to the storage device 20. The capture device 10 is tuned to the channel for the period of time, and transmits the received data stream of the broadcast program to the storage device 20.

Referring to FIG. 13B, when a user wishes to view a current broadcast program, the control device 30 transmits a command to an appropriate capture device or the device 10 so as to transmit a data stream of a broadcast program received by tuning to a particular channel for a particular period of time, to the control device 30, in order to provide the current broadcast program requested by the user to the display device 306. In response to the request, the capture device 10 transmits the data stream of the received broadcast program to the control device 30. When a user wishes to view a broadcast program which is already stored, the control device 30 transmits a command to the storage device 20 to transmit the data stream of the broadcast program stored in the storage device 20 to the control device 30, in order to provide the stored broadcast program which is requested by the user to the display device 306. In response to the request, the storage device 20 transmits the data stream of the stored broadcast program to the control device 30.

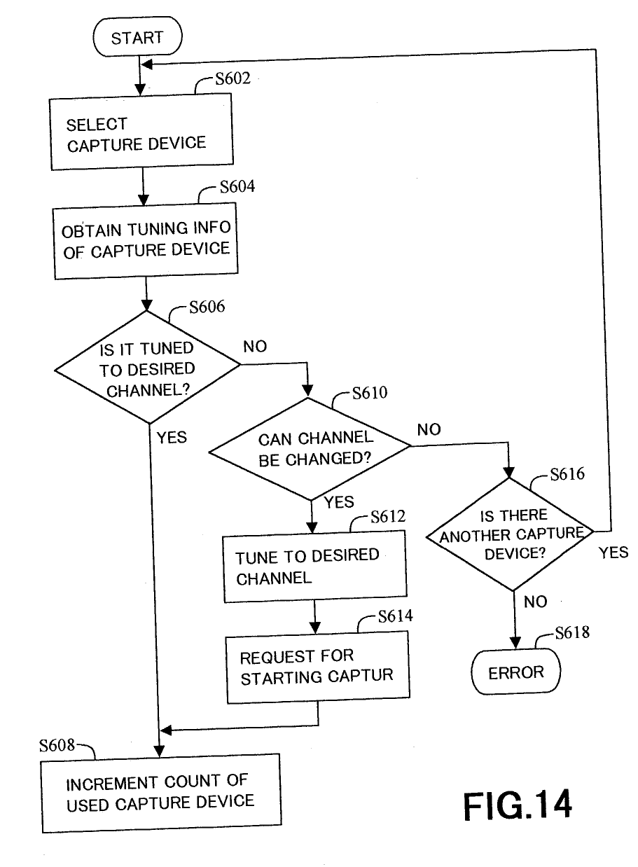

FIG. 14 is a flowchart for controlling the capture devices 10 to 14 that is executed by each of the control devices 30 to 34, as shown in FIG. 13A.

At Step 602, for example, the control device 30 selects one of the capture devices 10 to 14. At Step 604, the control device 30 acquires information related to the tuned state of the selected capture device, for example, the capture device 10. At Step 606, the control device 30 determines whether the current tuned channel is the desired channel or not, based on the tuning information. If it is determined that the channel is the desired channel, the control device 30 increments the count of use of the capture device by one (1) at Step 608. When the count of the capture device is one (1) or more, the capture device is currently being used, and the tuner 120 of the capture device is not permitted to be tuned to another channel.

If it is determined at Step 606 that the channel is not the desired channel, the control device 30 at Step 610 determines whether the tuned channel can be changed or not, by making an inquiry to the capture device 10 based on the tuning information. Alternatively, in accordance with a request by the control device 30, the capture device 10 may determine whether the tuned channel can be changed or not, based on the current state of operation and the list of reservations, and inform the control device 30 of the determination result. If it is determined that the channel can be changed, the control device 30 at Step 612 controls the tuner 120 so as to be tuned to the desired channel, and at Step 614 causes the capture device 10 to start the capturing operation. Thereafter the procedure proceeds to Step 608. If it is determined at Step 610 that the channel can not be changed, the control device 30 at Step 616 determines whether there is another capture device or not. If it is determined that there is another capture device, the procedure returns to Step 602. At Step 602, the control device 30 selects another capture device (11 to 14). If it is determined that there is no other capture device, the control device 30 performs the processing for error at Step 618. Alternatively, even if it is determined at Step 610 that the channel can be changed, the procedure may proceed to Step 616, and, at the subsequently iterated Step 606, the control device 30 may first search for a capture device in which the current tuned channel is the desired channel. If it is finally determined at Step 610 that there is no further capture device, the tuned channel of the capture device in which the tuned channel can be changed may be tuned to the desired channel at Step 612.

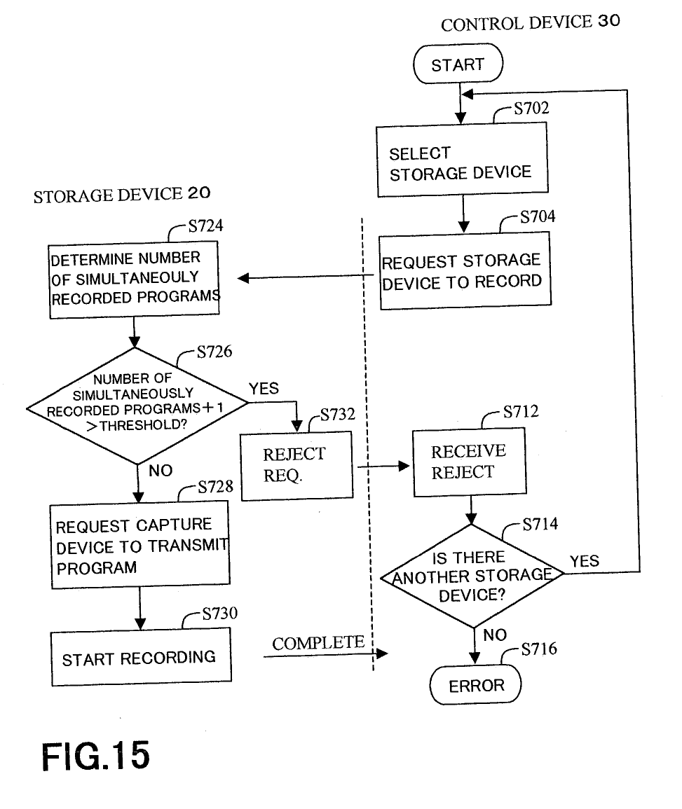

FIG. 15 is a flowchart for controlling the storage devices 20 to 24 that is executed by each of the control devices 30 to 34, as shown in FIG. 13A.

At Step 702, for example, the control device 30 selects one of the storage devices 20 to 24. At Step 704, the control device 30 transmits a request for recording a data stream of a desired program to the selected storage device, for example, the storage device 20. The storage device 20 can simultaneously record a plurality of programs. The storage device 20 at Step 724 determines the current number of the simultaneously recorded programs, and at Step 726 determines whether a value which is obtained by adding one (1) to the current number of the simultaneously recorded programs is larger than the threshold (the maximum tolerable number) or not. Alternatively, the determination may be performed by the control device 30. If it is determined that the value is not larger than the threshold, the storage device 20 at Step 728 requests the storage device 10 which has been determined in the flowchart of FIG. 14, to transmit the data stream of the program to the storage device 20. At Step 730, the storage device 20 starts the recording, and informs the control device 30 of the start of the recording.

If it is determined at Step 726 that the value is larger than the threshold, the storage device 20 at Step 732 transmits the rejection of the request to the control device 30. The control device 30 at Step 712 receives the rejection, and at Step 714 determines whether there is another storage device or not. If it is determined that there is another storage device, the procedure returns to Step 702, where the control device 30 selects another storage device (21 to 24). If it is determined that there is no other storage device, the control device 30 performs the processing for error at Step 716.

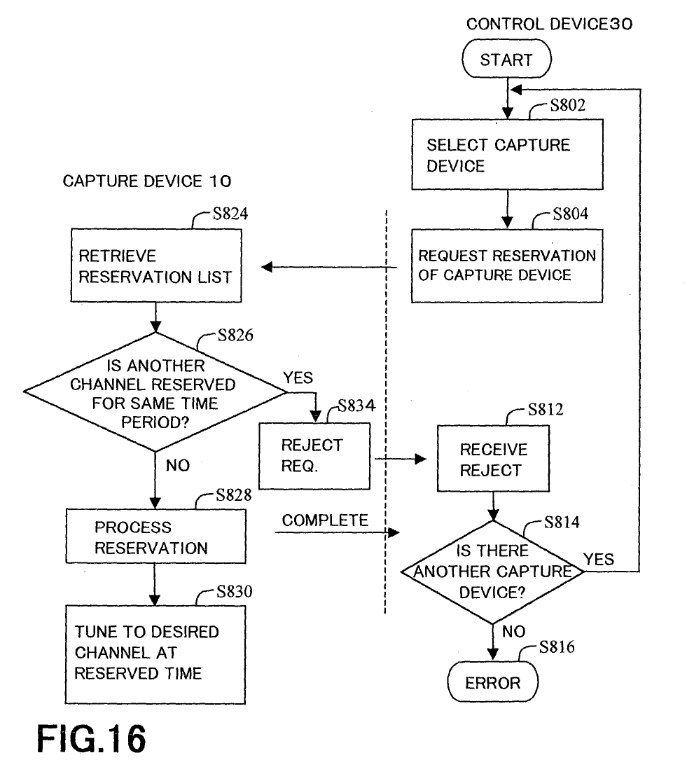

FIG. 16 is a flowchart for reserving the capture devices 10 to 14 for use that is executed by each of the control devices 30 to 34, as shown in FIG. 13A.

At Step 802, for example, the control device 30 selects one of the capture devices 10 to 14. At Step 804, the control device 30 transmits a request for a reservation for use of the selected capture device 10, to the capture device 10. The capture device 10 at Step 824 retrieves its own reservation list, and at Step 826 determines whether another channel is reserved for the same period of time or not, that is, whether the reservation of the desired channel is impossible or not. Alternatively, the determination may be performed by the control device 30. If it is determined that no other channel is reserved for the same period of time, the capture device 10 at Step 828 performs the processing for the reservation, and informs the control device 30 of the completion of the reservation. At Step 830, the capture device 10 causes the tuner 120 to be tuned to the desired channel at the reserved time.

If it is determined at Step 826 that another channel is reserved, the capture device 10 at Step 834 transmits the rejection of the request to the control device 30. The control device 30 receives the rejection at Step 812. At Step 814, the control device 30 determines whether there is another capture device or not. If it is determined that there is another capture device, the procedure returns to Step 802, where the control device 30 selects another capture device (11 to 14). If it is determined that there is no other capture device, the control device 30 performs the processing for error at Step 816.

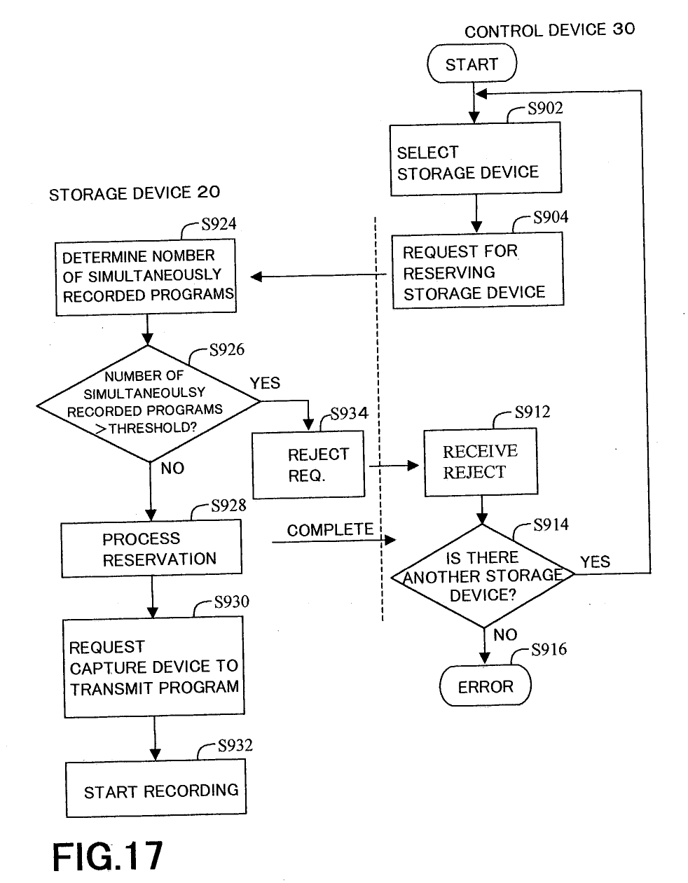

FIG. 17 is a flowchart for reserving the storage devices 20 to 24 for use that is executed by each of the control devices 30 to 34, as shown in FIG. 13A.

At Step 902, the control device 30 selects one of the storage devices 20 to 24. At Step 904, the control device 30 transmits a request for reserving of recording of a desired program to the selected storage device, for example, the storage device 20. The storage device 20 at Step 924 determines the current number of simultaneously recorded programs, and at Step 926 determines whether a value which is obtained by adding one (1) to the current number of the simultaneously recorded programs is larger than a threshold value (the maximum tolerable number) or not. Alternatively, the determination may be performed by the control device 30. If it is determined that the value is not larger than the threshold, the storage device 20 processes the reservation at Step 928, and informs the control device 30 of the completion of the reservation. The storage device 20 at Step 930 requests the capture device 10 to transmit the data stream of the program to the storage device 20 at the reserved time. At Step 932, the storage device 20 starts the recording, and informs the control device 30 of the start of the recording.

If it is determined at Step 926 that the value is larger than the threshold, the storage device 20 at Step 934 transmits the rejection of the request to the control device 30. The control device 30 at Step 912 receives the rejection, and at Step 914 determines whether there is another storage device or not. If it is determined that there is another storage device, the procedure returns to Step 902, where the control device 30 selects another storage device (21 to 24). If it is determined that there is no other storage device, the control device 30 performs the processing for error at Step 916.

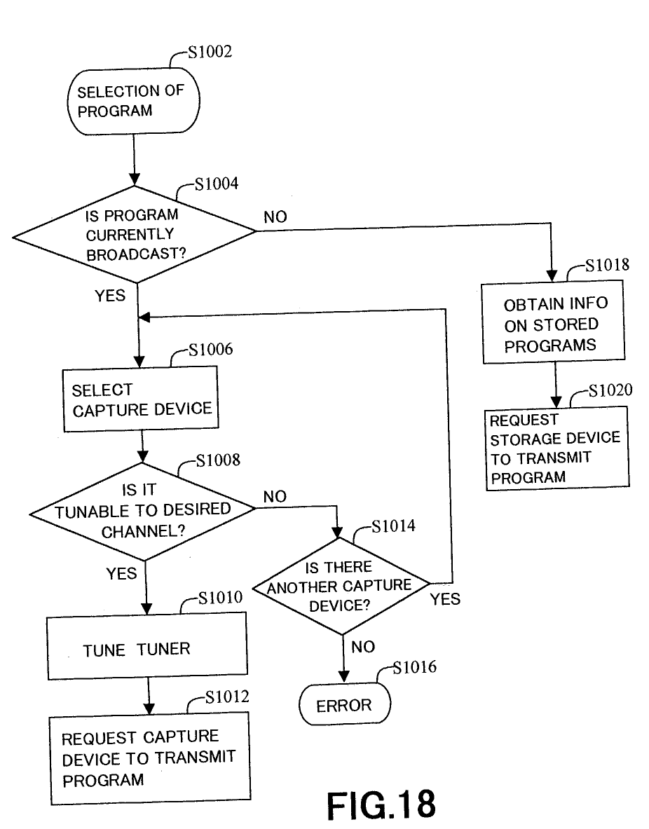

FIG. 18 is a flowchart for presenting a program that is executed by each of the control devices 30 to 34, as shown in FIG. 13B.

A user selects a desired current or past broadcast program while viewing the EPG shown in FIG. 12A or the list of recorded programs shown in FIG. 12B which is displayed on the display device 306-346, 324 or 506. In FIG. 12A, recorded programs are highlighted with, for example, characters in a different color or with a background of a different color. In FIG. 12A, they are indicated with dot shades.

When a desired program is selected by the user at Step 1002, the control device 30 at Step 1004 looks up the EPG and the list of recorded programs to determine whether the program is currently broadcast or not.

If it is determined that the program is not currently being broadcast, that is, when the program is already recorded, the control device 30 at Step 1018 requests the storage device, for example, the storage device 30, which stores the desired program, to transmit the program. When it is impossible to determine in which storage device the desired program is recorded, the control device 30 obtains the lists of recorded broadcast programs from the storage devices 20 to 24 for making the determination.

If it is determined at Step 1004 that the program is currently being broadcast, the control device 30 selects one of the capture devices 10 to 14 at Step 1006, and acquires information related to the tuned state of the selected capture device, for example, the device 10. At Step 1008, the control device 30 determines whether the tuner 120 can be tuned to the desired channel or not. Alternatively, the determination may be performed by the capture device 10. If it is determined that the tuning is possible, the control device 30 at Step 1010 controls the tuner 120 of the capture device 10 to be tuned to the desired channel. At Step 1012, the control device 30 transmits a request for transmitting the program, to the capture device 10. If it is determined that the tuning is not possible, the control device 30 at Step 1014 determines whether there is another capture device or not. If it is determined that there is another capture device, the procedure returns to Step 1006 in which the control device 30 selects another capture device (11 to 14). If it is determined that there is no other capture device, the control device 30 performs the processing for error at Step 1016.

In the capture devices 10 to 14 and the storage devices 20 to 24, the current state of operation and the precedent reservation take priority over a new capturing request and a new recording request. When the corresponding capture device 10 to 14 and storage devices 20 to 24 start the capturing and the recording in accordance with a request and a reservation, they may inform all of the control devices 30 to 34 of the starting.

When the loss rate of a packet of received data stream exceeds a predetermined threshold value, e.g., 10 bits per 10 seconds, each of the devices on the LAN 5 which receive a data stream from the capture devices 10 to 14 and the storage device 20 to 24, namely, each of the storage devices 20 to 24, the control devices 30 to 34, the terminals 50 to 54, and the reproduction and display devices 508 to 548 requests the capture device (10 to 14) or the storage device (20 to 24) serving as a device for transmitting the packet, to gradually reduce the bit rate of the transmitting data stream of a particular broadcast program in the manner shown in FIG. 9. Here, the reduction of the bit rate means the reduction in image quality and/or audio quality. In the MPEG standard, for example, B pictures are decimated, or higher order AC coefficients are cut off. Thereafter, when the loss rate of the packet becomes lower than another threshold value (for example, 4 bits per 10 seconds), the receiving device requests the corresponding transmitting device to gradually increase the bit rate. Preferably, the storage devices 20 to 24 employ a threshold value for a receiving data stream which is higher than that for the control devices 30 to 34, the terminals 50 to 54, and the reproduction and display devices 508 to 548. Such a particular broadcast program subject to the bit rate reduction may be a program with the lowest priority among broadcast programs which are delivered for the purpose of presentation in the control devices 30 to 34 or the reproduction and display devices 508 to 548, or among broadcast programs that are currently transmitted on the LAN 5. Accordingly, it is possible to prevent transmission data streams on the LAN 5 from exceeding the transmission capacity of the LAN 5.

Alternatively, the monitoring of the bit rate or traffic may be performed by another device, for example, the content server 40. In this case, the traffic is required to be controlled, the other device may notify it to the receiving devices, and the receiving devices may control the respective transmitting devices. Alternatively, the monitoring and control of the bit rate or traffic may performed by another device, for example, the content server 40, rather than by each receiving device. For example, the other device may control the traffic on the LAN 5 to gradually decrease, when the current traffic on the LAN 5 exceeds a threshold value which is equal to a predetermined ratio of the maximum capacity (for example, 70%), and may control the traffic on the LAN 5 to gradually increase, when the current traffic on the LAN 5 is lower than a threshold value which is equal to another predetermined ratio of the maximum capacity (for example, 50%).

Generally, an encrypted broadcast program is broadcast together with an encrypted descramble key. A control device or a reproducing device supplies the encrypted descramble key to a smart card to produce a decrypted descramble key. By using the produced descramble key, the encrypted broadcast program is descrambled and reproduced. A specific encrypted descramble key can be decrypted only by a specific smart card to produce a decrypted descramble key. The capture devices 10 to 14 filter out a data stream of an encrypted descramble key which usually has a relatively large amount, so that the data stream of the encrypted descramble key is not delivered on the LAN 5. The control devices 30 to 34 request the capture devices 10 to 14 beforehand, in the manner shown in FIG. 9, to transmit an encrypted descramble key for the control device or the corresponding reproducing device to the control device or the reproducing device when the capture devices receive the encrypted descramble key. When the capture devices 10 to 14 receive the encrypted descramble key for one of the control devices 30 to 34 or the corresponding reproducing device, the capture devices transmit the encrypted descramble key to the control device or the reproducing device, in accordance with the requests which have been received beforehand from the control devices 30 to 34.

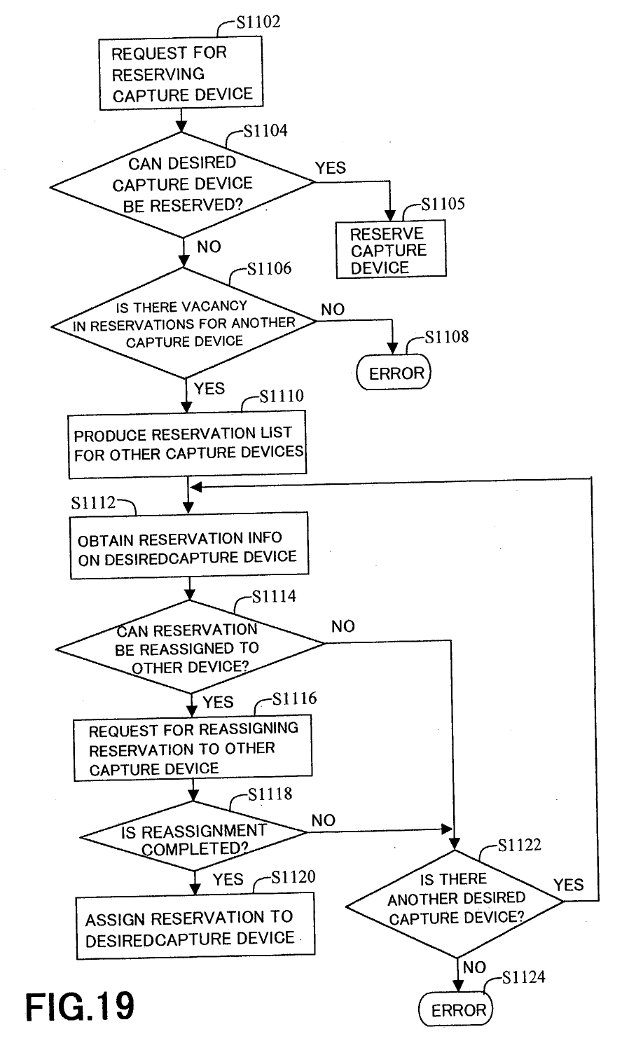

FIG. 19 is a flowchart for reserving and reassigning the reservations in the capture devices 10 to 14 depending on the receiving channels of the capture devices 10 to 14, executed by each of the control devices 30 to 34, as shown in FIG. 13B. Steps 1106 to 1124 in FIG. 19 are used in the error processing at Step 816 in FIG. 16.

Referring also to FIG. 9A, when a request for reserving of recording of a desired broadcast program by a user occurs, the control device 30 at Step 1102 selects the capture devices 10-11 having the tuner 120 which has a channel for receiving the desired broadcast program, for example, satellite broadcasting channel 1, and then requests the selected capture devices 10-11 to reserve them for use. At Step 1104, the control device 30 determines whether one of the capture devices 10 to 11 can be reserved or not, i.e., whether another channel is reserved for the same period of time or not. The determination whether the capture devices 10 to 11 can be reserved or not may be made by the respective capture devices, and results of the determinations may be notified to the control device 30. When the reservation can be made, one of the capture devices, for example, the capture device 10 is reserved at Step 1106.

If it is determined at Step 1104 that the capture device 10 can not be reserved, the control device 30 at Step 1106 checks the information related to the reservations of the other capture devices 12 to 14 having the tuner 120 which does not have the channel (for satellite broadcast) for receiving the desired program, to determine whether there is any vacancy for the reservations in another channel (for terrestrial broadcast) or not. Alternatively, the determination whether there is any vacancy for the reservation in the other channel (for terrestrial broadcast) in the other capture devices 12 to 14 or not may be performed by the respective capture devices 12 to 14, and results of the determinations may be notified to the control device 30. If it is determined that there is no vacancy for reservation in the other channel (for terrestrial broadcast), the procedure proceeds to Step 1108, and the processing for error is performed.

If it is determined that there is a vacancy for reservation in the other channel (for terrestrial broadcast), the control device 30 at Step 1110 produces a list of reservations for each of the other capture devices 12 to 14. At Step 1112, the control device 30 selects one of the desired capture devices 10 to 11, for example, the capture device 10, and acquires the information of reservations of the capture device. At Step 1114, the control device 30 determines whether a reservation of the other channel (for terrestrial broadcast) in the capture device 10 can be reassigned to the other capture device 11-14 or not, based on the lists of reservations. Alternatively, the determination whether the reservation of the other channel (for terrestrial broadcast) can be reassigned to one of the other capture devices 11 to 14 or not may be performed by the respective capture devices 11 to 14, and results of the determinations may be notified to the control device 30. If it is determined that the reassignment can not be performed, the procedure proceeds to Step 1122.

If it is determined that the reassignment can be performed, the control device 30 at Step 1116 requests the other control device 31-34, which has reserved the capturing of a data stream of the broadcast program on the other channel (for terrestrial broadcast) in the capture device 10, to reassign the reservation of the capturing of the program. At Step 1118, it is determined whether the reassignment is completed or not. If it is determined that the reassignment is completed, the control device at Step 1120 requests the desired capture device 10 to reserve the desired channel (satellite broadcast channel 1) for the desired program. If it is determined that the reassignment is not completed, the procedure proceeds to Step 1122.

At Step 1122, the control device 30 determines whether there is another desired capture device having the desired channel (satellite broadcasting channel 1) or not. If it is determined that there is another desired capture device ( . . . 14), the procedure returns to Step 1114, where the control device 30 acquires the information related to reservations of the other desired capture device ( . . . 14). If it is determined that there is no other desired capture device, the control device 30 performs the processing for error at Step 1124.

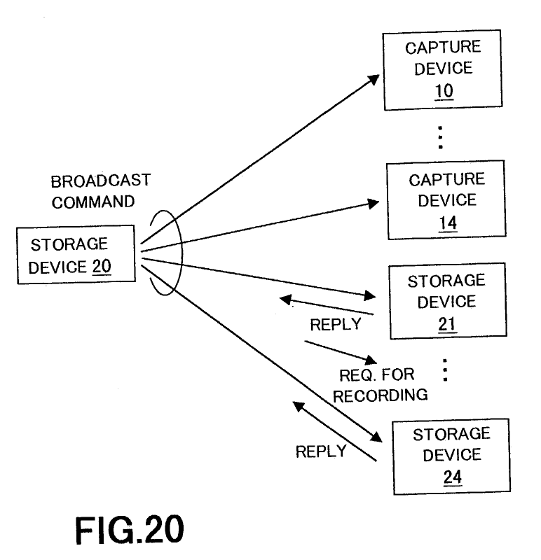

FIG. 20 shows an example of a procedure of changing a storage device for recording a data stream of a program, executed between the storage device 20 and the other storage device 21-24. The other storage devices 21 to 24 operate in the same manner as the storage device 20. When the storage capacity of the storage device 20 becomes insufficient during the recording of a data stream of a broadcast program, the storage device 20 broadcasts a search command for making an inquiry about an available capacity of the storage capacity, to the other storage devices 21 to 24. The other storage devices 21 to 24 reply to the command with their available capacities. The storage device 20 requests one of the other storage devices 21 to 24 that has an available capacity, to record a subsequent portion of the data stream that follows a last portion of the data stream recorded in the storage device 20.

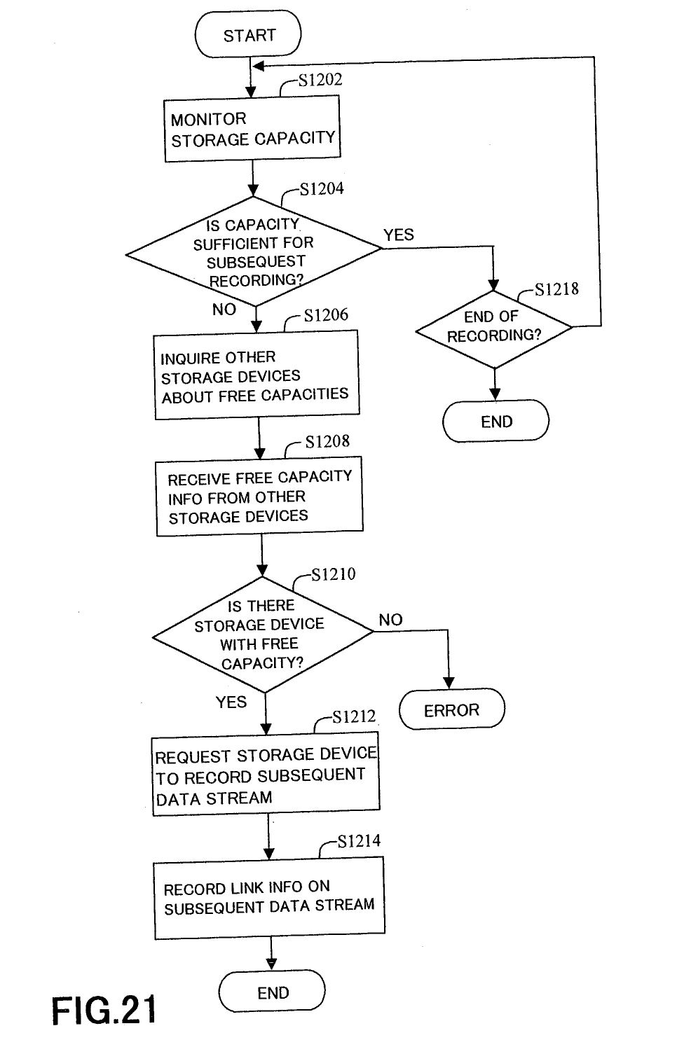

FIG. 21 is a flowchart for switching the storage devices for recording a data stream of a broadcast program that is executed by each of the storage devices 20 to 24. The flowchart of FIG. 21 is executed at Step 730 of FIG. 15 or at Step 932 of FIG. 17.

At Step 1202, the controller/analyzer 210 of each of the storage devices 20 to 24 monitors remaining free capacity of its large-capacity recording medium 220 while data stream of a current program is being recorded. At Step 1204, the controller/analyzer 210 determines whether the free capacity of the large-capacity recording medium 220 is sufficient to record the subsequent portion of the data stream of the program or not, based on the type of the program, the record time period and the like. If it is determined that it is sufficient, the controller/analyzer 210 at Step 1218 determines whether the recording of the program is ended or not. If the recording is not ended, the procedure returns to Step 1202. If the recording is ended, the procedure exits from the routine shown in FIG. 21.

If it is determined that the remaining free capacity is not sufficient, the controller/analyzer 210 at Step 1206 makes inquiry about free capacities of the other storage devices 21 to 24, in the manner as described above. At Step 1208, the controller/analyzer 210 receives information related to the free capacities of the other storage devices 21 to 24. At Step 1210, the controller/analyzer 210 determines whether there is a storage device with a free capacity or not, based on the information. If it is determined that there is no storage device with a free capacity, the controller/analyzer 210 performs the processing for error.

If it is determined at Step 1210 that there is one or more storage devices with a free capacity, the controller/analyzer 210 at Step 1212 requests one of the storage devices with a free capacity, for example, the storage device 21, to record the subsequent portion of the data stream. At Step 1214, the controller/analyzer 210 adds information indicating a link to the subsequent portion of the data stream, to the last recorded portion of the data stream of the broadcast program recorded in the large-capacity recording medium 220. The controller/analyzer 210 informs the corresponding control device, for example, the control device 30 of the switching between the storage devices. The link information indicates the recording position of the start of the subsequent portion of the data stream in the large-capacity recording medium 220 of the storage device 21. Thereafter, the procedure exits from the routine of FIG. 21. When the control devices 30 to 34 receive the information indicating the link from the storage device 20 during the receiving of a data stream from the storage device 20, the control devices 30 to 34 request the other storage device 21 in which the subsequent portion of the data stream is recorded, to transmit the subsequent portion of the data stream.

At Step 1206, the controller/analyzer 210 may first inform the corresponding one of the control devices (30 to 34) of the shortage of the storage capacity, and Steps 1206 to 1214 may be executed by the control device (30 to 34).

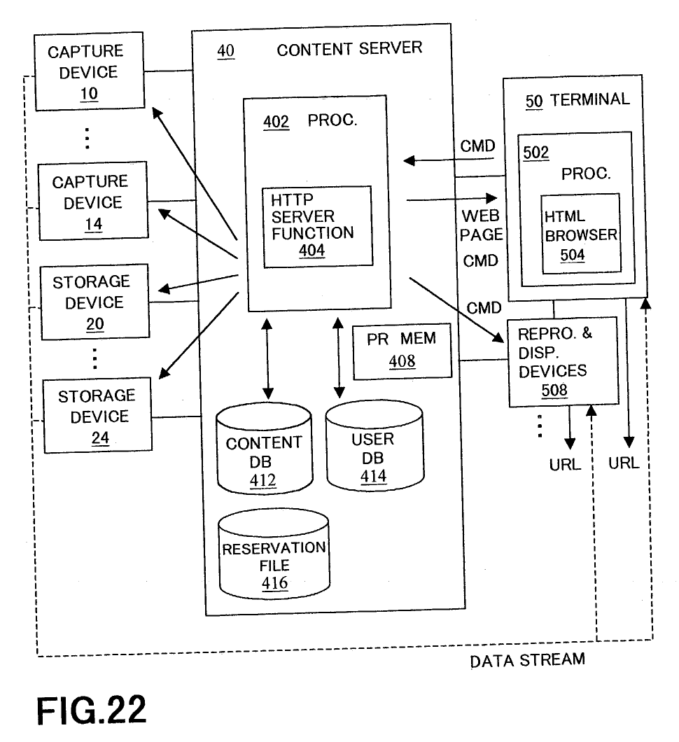

FIG. 22 shows the configuration of the content server 40 in FIGS. 3 and 4. The content server 40 includes: a processor 402 having a CPU, a ROM and a RAM; a program memory 408 for storing an application program, such as a hard disk device or a RAM; and a content database 412, a user database 414 and a reservation file 416 which are stored in a storage device such as a hard disk device. An HTTP server function 404 is implemented on the processor 402 in the form of hardware or software. The program memory 408 stores an application program, in which a function, for example, the HTTP server function 404, is implemented.

The HTTP server function 404 receives a command together with a user ID and a password from the terminals 50 to 54, so as to authenticate the user. In response to the command, the HTTP server function 404 controls the capture devices 10 to 14 and the storage devices 20 to 24, so that the data stream of the required broadcast program is provided directly or via the server 40 from the capture devices 10 to 14 or the storage devices 20 to 24 to the terminals 50 to 54 or the reproduction and display devices 508 to 548, and also so that recording of the data stream of the requested broadcast program is reserved, and the data stream of the broadcast program from the capture devices 10 to 14 is recorded into the storage devices 20 to 24 for the reserved period of time. In this case, the capture devices 10 to 14 or the storage devices 20 to 24 do not need to perform the authentication of a user.

Each of the terminals 50 to 52, which is typically a PC, includes a processor 502 having a CPU, a ROM and a RAM. An application program, such as an HTML browser 504, is implemented on the processor 502.

A user accesses the server 40 by using a URL on, for example, the browser 504 of the terminal 50. In response to the access of the user, the server function 404 provides, to the terminal 50-54, a Web page for reserving of delivery and recording of a broadcast program, and controls the capture devices 10 to 14 and the storage devices 20 to 24 in accordance with the selection and the input data by the user on the Web page. The selection and the input data are transmitted as an HTTP command to the server function 404. The server function 404 converts the HTTP command into a network command for the capture devices 10 to 14 and the storage devices 20 to 24, to control the capture devices 10 to 14 and the storage devices 20 to 24 in the same manner as the above-described control devices 30 to 34. However, in the reassignment of reservations, as shown in FIG. 19 for example, the other capture device at Steps 1106, 1110 and 1122 corresponds to another user, and the other capture device at Step 1116 corresponds to the server function 404 per se.

At Steps 1012 and 1020 in FIG. 18, the server function 404 transmits, to the corresponding terminal 50 to 54 or the corresponding reproduction and display device 508 to 548, a command to access a Web site of the URL of a corresponding one of the capture devices 10 to 14 and the storage devices 20 to 24, together with the URL. The terminals 50 to 54 or the reproduction and display devices 508 to 548 access the corresponding one of the capture devices 10 to 14 and the storage devices 20 to 24 by using the received URL, to receive a data stream of a broadcast program.

The server function 404 stores a reservation list of the recording of the broadcast program requested by the user terminals 50 to 52, into the reservation file 416. The content server 40 centrally manages the reservations, so that it is not necessary for the capture devices 10 to 14 and the storage devices 20 to 24 to manage the reservations. The list includes the information related to the identification, the period of time, the capture device to be used and the tuned channel of the broadcast program to be recorded, the storage device to be used, the ID of the user who has made the reservation, the identification and address of the terminal, and the identification and address of the reproduction and display device. When a plurality of users request recording of the same program, the IDs of all the users who performed the reservations, the identifications and addresses of the terminals, and the identifications and addresses of the reproduction and display devices are incorporated into the list.

In response to requests of recording of a broadcast program by a plurality of users, the server function 404 selects, for example, capture devices, storage devices and the like which are to be used in the recording schedule, in accordance with the principle of the algorithms of the flowcharts shown in FIGS. 16, 17 and 19.

At the start time of the broadcast program in the list, the server function 404 transmits the request for tuning of the tuner and reception of the program, to the corresponding capture device, and transmits the request for reception and recording of the program from the capture device, to the corresponding storage device.

When a user requests deletion of a program which is recorded in the storage devices 20 to 24 through the terminal, the server function 404 deletes the corresponding user ID, and the like from the list. When all of the user IDs and the like related to a particular program are deleted from the list, the server function 404 requests the corresponding storage device to delete the corresponding program.

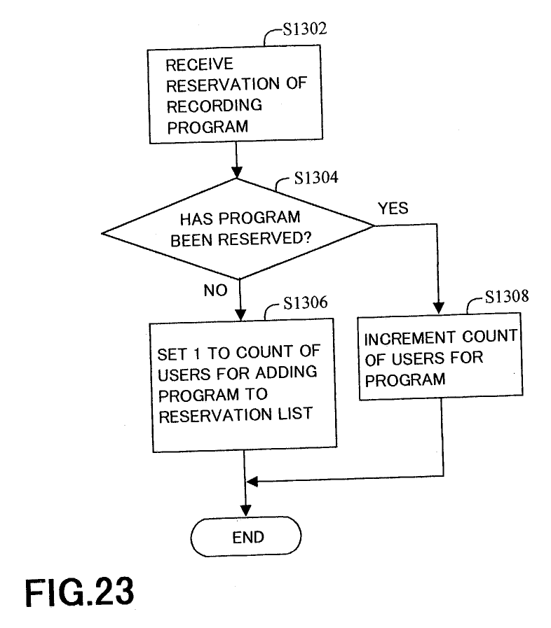

FIG. 23 is a flowchart for receiving requests for reservations of recording broadcast programs from the plurality of user terminals 50 to 52 that is executed by the server function 404 of the content server 40.

A user accesses the content server 40 by using the browser 504 on the terminal 50, to reserve recording of a broadcast program. At Step 1302, the server function 404 receives the request for reserving the recording of the program from the terminal 50. At Step 1304, the server function 404 looks up the reservation file 416 to determine whether the program is already reserved by another terminal or not. If it is determined that the program is already reserved, the server function 404 at Step 1306 increments the count of users for the program in the reservation file 416. If it is determined that the program has not been reserved, the server function 404 adds the recording of the program to the reservation file 416 at Step 1308, and resets the user count for the program to one (1).

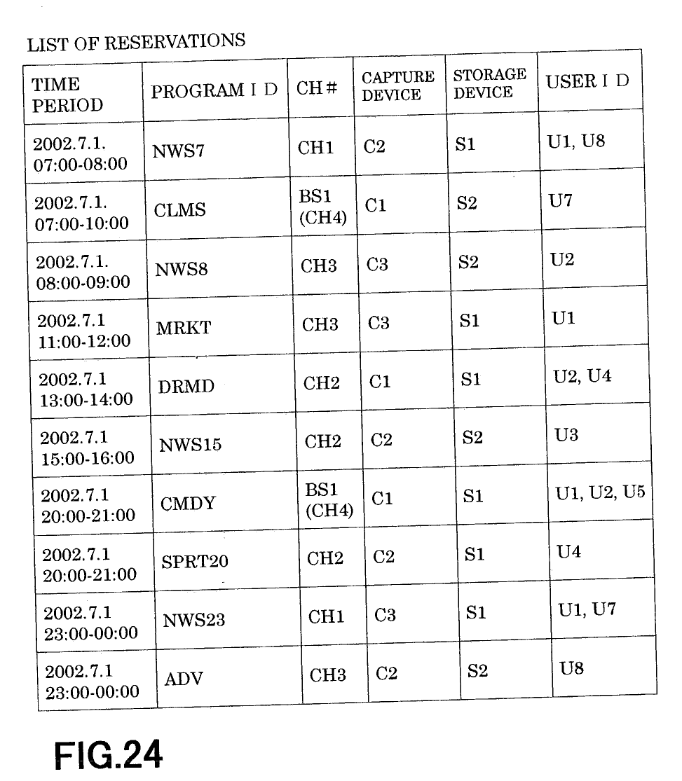

FIG. 24 shows an example of a list of reservations stored in the reservation file 416.

The above-described embodiments are only typical examples, and their modifications and variations are apparent to those skilled in the art. It should be noted that those skilled in the art can make various modifications to the above-described embodiments without departing from the principle of the invention and the accompanying claims.

What is claimed is:

1. A control device which is connectable to a plurality of data stream capture devices and one or more storage devices via a local area network, wherein
said control device comprises a processor;
said processor is adapted to request, in response to a user's request, one of said plurality of capture devices to tune to a desired channel and receive a desired data stream, when it is determined that said one capture device is tunable to said channel; and
said processor is adapted to request, in response to the user's request, one of said one or more storage devices to record the data stream from said one capture device, when it is determined that said one storage device can record the data stream.

2. A control device according to claim 1, wherein, when said one capture device is to be tuned to another channel, said processor causes another one of said plurality of capture devices to be tuned to said other channel in stead of said one capture device, and then provides said request to said one capture device.

3. A control device according to claim 1, wherein, when an amount stored in said one storage device reaches a limit while said one storage device is recording the data stream, said processor requests another one of said one or more storage devices to record a subsequent portion of the data stream.

4. A control device according to claim 1, wherein the data stream is a data stream of a program which is scheduled to be broadcast in the future.

5. A control device according to claim 1, wherein said processor receives program guide data in a predetermined format from one of said plurality of capture devices.

6. A control device according to claim 1, wherein said processor requests said one capture device to transmit a decryption key which is necessary for reproducing the data stream.

7. A control device according to claim 1, wherein said processor requests said one capture device to change a bit rate of a data stream to be transmitted.

8. A control device according to claim 1, wherein said processor requests said one storage device to change a bit rate of a data stream to be transmitted.

9. A control device according to claim 1, wherein said processor receives and reproduces the data stream, and provide the reproduced data stream to a display device.

10. A control device according to claim 1, wherein a reproducing device which is connectable to said local area network is associated with said control device.

11. A control device according to claim 1, wherein the user's request is received via said local area network.

12. A control device which is connectable to a plurality of data stream capture devices and to one or more storage devices via a local area network, wherein said control device comprises a processor;
said processor is adapted to request one of said plurality of capture devices to be tuned to a channel on which a data stream desired by a user can be received and to receive and provide said desired data stream, when said desired data stream is currently being broadcast, and when it is determined that said one capture device is tunable to said channel; and
said processor is adapted to request one of said one or more storage devices that stores said data stream desired by the user to provide said desired data stream, when it is determined that said desired data stream was broadcast in the past.

13. A data stream capture device which is connectable to one or more storage devices and to a plurality of user devices via a local area network, wherein
said data stream capture device comprises a processor and a tuner;
said processor is adapted to cause, in accordance with a received request, said tuner to be tuned to a desired channel and to receive a desired data stream, when it is determined that said tuner is tunable to said channel;
said processor is adapted to transmit, in response to a received request, said data stream in a predetermined format to said user device; and
said processor is adapted to transmit said data stream to said storage device in response to a received request.

14. A capture device according to claim 13, wherein said processor converts received program guide data in a particular format into program guide data in a predetermined format, and transmits the converted program guide data to said user device.

15. A capture device according to claim 13, wherein, when said tuner is not required to be tuned, elements other than an element required for receiving a command from said local area network are deenergized.

16. A capture device according to claim 13, wherein said capture device receives a reservation of tuning in accordance with the received request.

17. A capture device according to claim 13, wherein said processor transmits the data stream at one of a plurality of bit rates, in response to the received request.

18. A capture device according to claim 13, wherein said processor transmits, in accordance with a received request, a description key which is necessary for reproducing the data stream to said user device, while a description key is not normally transmitted.

19. A storage device which is connectable to a plurality of data stream capture devices and a plurality of user devices via a local area network, wherein
said storage device comprises a processor and a recording medium;
said processor is adapted to record, in response to a received request, a desired data stream from said capture device on a recording medium, when it is determined that a data stream can be recorded on said recording medium; and
said processor is adapted to provide in response to a received request, a data stream recorded on said recording medium, in a predetermined format, to one of said plurality of user devices.

20. A storage device according to claim 19, wherein
said storage device simultaneously records a plurality of data streams on said recording medium, in accordance with a plurality of received requests; and
said processor accepts a new request for recording, unless the number of data streams which can be simultaneously recorded exceeds a threshold.

21. A storage device according to claim 19, wherein, when it is determined that an amount stored in said storage device reaches a limit during recording of the data stream, said processor requests another storage device to record a subsequent portion of the data stream, via said local area network.

22. A storage device according to claim 19, wherein said processor deletes one of the data streams recorded on said recording medium that has a lower priority.

23. A storage device according to claim 19, wherein said processor deletes older ones of the data streams recorded on said recording medium.

24. A storage device according to claim 19, wherein said storage device receives a request for a reservation of recording in accordance with the received request.

25. A storage device according to claim 19, wherein said processor transmits the data stream at one of a plurality of bit rates, in response to the received request.

26. A system for capturing, storing and delivering a data stream, comprising a plurality of data stream capture devices, one or more storage devices and a plurality of user devices, said devices being connectable to each other via a local area network, wherein
said user device transmits a request to said capture device in accordance with a user's request;
said user device transmits a request to said storage device in accordance with the user's request;
when it is determined that one of said plurality of capture devices is tunable to a channel for a desired broadcast program, in accordance with a request from one of said plurality of user devices, said one capture device tunes to the channel, and receives and provides a data stream of the program;
in accordance with a request from one of said plurality of user devices, one of said one more storage devices records the data stream of the desired program from said one capture device which is tuned to the channel; and
in accordance with a request from one of said plurality of user devices, one of said one or more storage devices transmits a desired recorded data stream.

27. A program stored on a storage medium for an information processing device which is connectable to a plurality of data stream capture devices and to one or more storage devices via a local area network, said program being operable to effect the steps of:
requesting, in response to a user's request, one of said plurality of capture devices to be tuned to a desired channel and receive a desired data stream, when it is determined that said one capture device is tunable to said channel; and
requesting, in response to the user's request, one of said one or more storage devices to record the data stream from said one capture device, when it is determined that said one storage device can record the data stream.

28. A program according to claim 27, being operable to further effect the step of causing, when said one capture device is to be tuned to another channel, another one of said plurality of capture devices to be tuned to the other channel in stead of said one capture device, and then provides said request to said one capture device.

29. A program according to claim 27, being operable to further effect the step of requesting another one of said one or more storage devices to record a subsequent portion of the data stream, when an amount stored in said one storage device reaches a limit while said one storage device is recording the data stream.

30. A program according to claim 27, being operable to further effect the step of receiving program guide data in a predetermined format from one of said plurality of capture devices.

31. A program according to claim 27, being operable to further effect the step of requesting said one capture device to transmit a description key which is necessary for reproducing the data stream.

32. A program according to claim 27, being operable to further effect the step of requesting said one capture device to change a bit rate of a data stream to be transmitted.

33. A program according to claim 27, being operable to further effect the step of requesting said one storage device to change a bit rate of a data stream to be transmitted.

34. A program according to claim 27, being operable to further effect the step of receiving and reproducing the data stream, and provide the reproduced data stream to a display device.

35. A program stored on a storage medium for a control device which is connectable to a plurality of data stream capture devices and to one or more storage devices via a local area network, said program being operable to effect the steps of:
requesting one of said plurality of capture devices to be tuned to a channel on which a data stream desired by a user can be received and to receive and provide said desired data stream, when said desired data stream is currently being broadcast, and when it is determined that said one capture device is tunable to said channel; and
requesting one of said one or more storage devices that stores said data stream desired by the user to provide said desired data stream, when it is determined that said desired data stream was broadcast in the past.

36. A program stored on a storage medium for a data stream capture device which is connectable to one or more storage devices and to a plurality of user devices via a local area network, said program being operable to effect the steps of:
causing, in accordance with a received request, a tuner to be tuned to a desired channel and to receive a desired data stream, when it is determined that said tuner is tunable to said channel;
transmitting, in response to a received request, said data stream in a predetermined format to said user device; and
transmitting said data stream to said storage device in response to a received request.

37. A program according to claim 36, being operable to further effect the step of converting received program guide data in a particular format into program guide data in a predetermined format, and transmitting the converted program guide data to said user device.

38. A program according to claim 36, being operable to further effect the step of receiving a reservation of tuning in accordance with the received request.

39. A program according to claim 36, being operable to further effect the step of transmitting the data stream at one of a plurality of bit rates, in response to the received request.

40. A program according to claim 36, being operable to further effect the step of transmitting, in accordance with a received request, a description key which is necessary for reproducing the data stream to said user device, while a description key is not normally transmitted.

41. A program stored on a storage medium for a storage device which is connectable to a plurality of data stream capture devices and to a plurality of user devices via a local area network, said program being operable to effect the steps of:
recording, in response to a received request, a desired data stream from said capture device on a recording medium, when it is determined that a data stream can be recorded on said recording medium; and
providing, in response to a received request, a data stream recorded on said recording medium, in a predetermined format, to one of said plurality of user devices.

42. A program according to claim 41, being operable to further effect the steps of:
accepting a new request for recording, unless the number of data streams which can be simultaneously recorded exceeds a threshold; and
simultaneously recording a plurality of data streams on said recording medium, in accordance with a plurality of received requests.

43. A program according to claim 41, being operable to further effect the step of requesting another storage device to record a subsequent portion of the data stream, via said local area network, when it is determined that an amount stored in said first storage device reaches a limit during recording of the data stream.

44. A program according to claim 41, being operable to further effect the step of receiving a request for a reservation of recording in accordance with the received request.

45. A program according to claim 41, being operable to further effect the step of transmitting, in response to the received request, the data stream at one of a plurality of bit rates.

46. In an information processing device which is connectable to a plurality of data stream capture devices and to one or more storage devices via a local area network, a method for controlling said plurality of data stream capture devices and said one or more storage devices, said method comprising the steps of:
requesting, in response to a user's request, one of said plurality of capture devices to be tuned to a desired channel and receive a desired data stream, when it is determined that said one capture device is tunable to said channel; and
requesting, in response to the user's request, one of said one or more storage devices to record the data stream from said one capture device, when it is determined that said one storage device can record the data stream.

47. A method according to claim 46, further comprising the step of causing, when said one capture device is to be tuned to another channel, another one of said plurality of capture devices to be tuned to said other channel in stead of said one capture device, and then provides said request to said one capture device.

48. A method according to claim 46, further comprising the step of requesting another one of said one or more storage devices to record a subsequent portion of the data stream, when an amount stored in said one storage device reaches a limit while said one storage device is recording the data stream.

49. In an information processing device which is connectable to a plurality of data stream capture devices and to one or more storage devices via a local area network, a method for controlling said plurality of data stream capture devices and said one or more storage devices, said method comprising the steps of:
requesting one of said plurality of capture devices to be tuned to a channel on which a data stream desired by a user can be received and to receive and provide said desired data stream, when said desired data stream is currently being broadcast, and when it is determined that said one capture device is tunable to said channel; and
requesting one of said one or more storage devices that stores said data stream desired by the user to provide said desired data stream, when it is determined that said desired data stream was broadcast in the past.

50. In a data stream capture device which is connectable to one or more storage devices and to a plurality of user devices via a local area network, a method for controlling said one or more storage devices and said plurality of user devices, said method comprising the steps of:
causing, in accordance with a received request, a tuner to be tuned to a desired channel and to receive a desired data stream, when it is determined that said tuner is tunable to said channel;
transmitting, in response to a received request, said data stream in a predetermined format to said user device; and
transmitting said data stream to said storage device in response to a received request.

51. A method according to claim 50, further comprising the step of converting received program guide data in a particular format into program guide data in a predetermined format, and transmitting the converted program guide data to said user device.

52. A method according to claim 50, further comprising the step of transmitting the data stream at one of a plurality of bit rates, in response to a received request.

53. A method according to claim 50, further comprising the step of transmitting, in accordance with a received request, a description key which is necessary for reproducing the data stream to said user device, while a description key is not normally transmitted.

54. In a storage device which is connectable to a plurality of data stream capture devices and to a plurality of user devices via a local area network, a method for controlling said plurality of data stream capture devices and said plurality of user devices, said method comprising the steps of:
recording, in response to a received request, a desired data stream from said capture device on a recording medium, when it is determined that a data stream can be recorded on said recording medium; and
providing, in response to a received request, a data stream recorded on said recording medium, in a predetermined format, to one of said plurality of user devices.

55. A method according to claim 54, further comprising the steps of:
accepting a new request for recording, unless the number of data streams which can be simultaneously recorded exceeds a threshold; and
simultaneously recording a plurality of data streams on said recording medium, in accordance with a plurality of received requests.

56. A method according to claim 54, further comprising the step of requesting another storage device to record a subsequent portion of the data stream, via said local area network, when it is determined that an amount stored in said first storage device reaches a limit during recording of the data stream.

57. A method according to claim 54, further comprising the step of receiving a request for a reservation of recording in accordance with the received request.
